(19) United States
(12) Patent Application Publication
(10) Pub. No.: US 2026/0166766 A1
(43) Pub. Date: Jun. 18, 2026

(54) ELECTRIC HAIR CUTTER

(71) Applicant: Braun GmbH, Kronberg (DE)

(72) Inventor: Thomas Verstege, Frankfurt (DE)

(21) Appl. No.: 19/423,479

(22) Filed: Dec. 17, 2025

(30) Foreign Application Priority Data
Dec. 17, 2024 (EP) 24220758.7

(51) Int. Cl. B26B 19/06; B26B 19/04

(52) U.S. Cl. CPC B26B 19/063; B26B 19/048

(57) ABSTRACT

The present invention relates to a cutter system for an electric hair cutter such as shaver and/or trimmer, comprising a pair of cooperating cutting elements which are movably supported relative to each other by a support structure which provides for a swivel axis about which said cooperating cutting elements are swivelable to follow the skin contour, said swivel axis extending substantially parallel to a skin contact surface of said cutter system. The support structure may include a plurality of ring-like, curved swivel rails attached to and projecting from a bottom surface of the cutter system opposite to the skin contact surface thereof.

### FIELD OF THE INVENTION

The present invention relates to cutting body hair such as beard stubbles of multidays'beard and daily shaving. More particularly, the present invention relates to a cutter system for an electric hair cutter such as a shaver and/or trimmer, comprising a pair of cooperating cutting elements, wherein said cutting elements are movably supported relative to each other by a support structure which provides for a swivel axis about which said cooperating cutting elements are swivelable to follow the skin contour, said swivel axis extending substantially parallel to a skin contact surface of the cutter system.

### BACKGROUND OF THE INVENTION

Electric hair cutters like shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating cutting elements with comb-like edges including one or more rows of comb-like or rake-like cutting teeth reciprocating or rotating relative to each other, are often used for cutting longer beard stubbles or problem hair that is difficult to cut due to, for example, a very small angle to the skin or growing from very resilient skin. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric shavers or trimmers which at the same time may be provided with the aforementioned shear foil cutters. For example, cutting elements may include two rows of comb-like cutting teeth arranged, for example, at opposite sides of the cutting elements and a field of shear foil-like cutting perforations between said rows of comb-like cutting teeth.

For example, EP 24 25 938 B1 shows a shaver with a pair of long hair trimmers integrated between shear foil cutters. Furthermore, EP 27 47 958 B1 and CN 206 287 174 U disclose hair trimmers having two rows of cooperating cutting teeth arranged at opposite sides of the shaver head. A similar cutter system is shown in US 2017/0050326 A1 wherein in such cutter system the lower comb-like cutting element is fixed and the upper comb-like cutting element is movable.

Shavers and/or trimmers combining rows of comb-like cutting teeth at opposite edges and shear foil-like cutting perforations between said rows of comb-like teeth are shown in documents CN 209 478 241 U and US 2018/0257248 A1.

Similar cutter system are disclosed by EP 31 31 716 B1, wherein the support structure includes an outer frame holding the outer cutting element at opposite edge portions thereof, wherein the support structure includes a four-bar linkage mechanism connecting the cutter system to a handle of the trimmer and allowing the cutting elements to swivel about a swivel axis parallel to the axis of reciprocating. Due to the four-bar linkage system, said swivel axis is no fixed axis, but may move along a path defining the possible positions of the instantaneous center of rotation. Such four-bar-linkage tends to be flexible and thus, may affect the transmission of driving action to the cutting elements via a drive train bridging the gap between the handle and the cutter head.

Furthermore, EP 3 907 045 A1 and EP 3 907 046 A1 disclose electric beard trimmers comprising a cutter system including a pair of cutter elements reciprocating relative to each other along a reciprocating axis, wherein the cutter system may swivel about a swivel axis parallel to said reciprocating axis. The support structure allowing for such swiveling includes a fork-like support frame having two projecting arms between which the cutter system is rotatably supported at longitudinal end portions. Since the projecting arms of the support frame may not extend beyond the skin contact surface defined by the upper cutter element to avoid interference with and irritation of the skin, the swivel axis needs to be positioned below the skin contact surface for technical design reasons. Consequently, undesired swiveling may occur due to friction when moving the cutter system along skin contours.

Furthermore, U.S. Pat. No. 7,461,458 B2 shows a wet shaver having a razor cartridge that may swivel relative to the elongated handle by means of a swivel frame comprising a pair of spaced apart arms each having swiveling connecting structure at the outer portion thereof, wherein such swiveling connecting structure comprises shell bearings defining a curved sliding path for swivel bearing elements of the razor cartridge. So as to control swiveling movements, creep control arms are provided between said spaced apart support arms of the swivel frame. As the creep control arms occupy the central space between the swivel frame arms, such support structure cannot be used for electric shavers needing the central space for a drive train for driving the cutter elements relative to each other to make them, for example, reciprocate relative to each other. On the other hand, eliminating the creep control arms is hardly possible since the support structure would then lack the necessary preciseness and control of the swiveling movement. Furthermore, there would be slack and too much play for effectively transmitting the driving motion.

Furthermore, EP 4 360 830 A1 discloses an electric hair cutter including a cutter head with a cutter system that may pivot relative to the handle. So as to allow such pivoting of the cutter system, the cutter head is provided with a sliding bearing including a pair of convex support surfaces along which a counterpart may slide, which counterpart has cranked end sections provided with additional pivot bearings. In addition, overhanging sections of said counterpart engaging with slot portions under said convex support surfaces prevent the sliding bearing from losing contact. Due to the various bearing portions, assembly of the support structure is rather complicated and furthermore, the sliding bearing structure shows a tendency to get slammed.

Generally, such beard stubble trimmers and shavers need to address quite different and diverging functional requirements and performance issues such as closeness, thoroughness, good visibility of the cutting location, efficiency and pleasant skin feel, good ergonomics and handling. Closeness means short or very short remaining stubbles, whereas thoroughness means less missed hairs particularly in problem areas like the neck. Efficiency means less and faster strokes suffice to achieve the desired trimming result. Pleasant skin feel depends on the individual user, but often includes less irritation in form of nicks, cuts or abrasion and better gliding onto the skin. Visibility of the cutting location is particularly important in case of styling or edging contours to accomplish hair removal with local accuracy.

Fulfilling such various performance issues at the same time is quite difficult. Meeting such needs becomes even more difficult when different types of cutting contours such as shear foil-like perforations and comb-like rows of teeth are integrated into the same cutting elements such as C-shaped cutting blades reciprocating relative to each other since such multiple-function cutter elements may not be adapted exclusively to one specific cutting function.

### SUMMARY OF THE INVENTION

It is an objective underlying the present invention to provide for an improved cutter system avoiding at least one of the disadvantages of the prior art and/or further developing the existing solutions. A more particular objective underlying the invention is a good adaption of the cutter system to the skin contour without posing risks of skin injuries due to uncontrolled swiveling of the cutting elements. Another objective underlying the present invention is to create an advantageous swivel support structure for the cutter elements with design freedom for positioning the swivel axis, without sacrificing efficiency of the transmission of driving forces to the cutter elements.

According to an aspect, the cutter system may swivel relative to a handle about a swivel axis positioned on or close to the skin contact surface without needing support frame arms projecting beyond the skin contact surface to avoid skin irritations. More particularly, the support structure may include a plurality of ring-like, curved swivel rails attached to and projecting from a bottom surface of the cutter system opposite to the skin contact surface thereof. Such curved swivel rails define the swivel axis and may be movably received in shell bearings of a lower support frame structure that may be attached to a handle of the shaver and/or trimmer. Due to the curvature of the swivel rails, the cutter systems may swivel relative to the lower support frame structure and thus, relative to the handle of the hair cutter, when the curved swivel rails move through or along the shell bearings thereof.

Said curved swivel rails may be formed from steel wire, whereas the shell bearings may be made from plastics. More particularly, the shell bearings may form multiple-points-bearings, wherein each of said shell bearings may include a plurality of spaced apart bearing points together defining a curved guiding slot in which a curved swivel rail may be received. Multiple spaced-apart bearing points instead of one continuous curved slot with constant width makes the bearing structure more independent from ring diameter variations due to bending tolerances, wherein the distance or gap width between cooperating pairs of bearing points on opposite sides of a rail may be chosen smaller resulting in smaller play without increasing the tendency of the curved rail getting stuck in the respective shell bearing.

The shell bearings may be configured to hold each of the curved swivel rails free of play and thus rigidly and fixedly in a direction perpendicular to the pivot axis, whereas in a direction parallel to the pivot axis only one curved swivel rail may be fixedly held, and the other swivel rail or all other swivel rails may have play or may be displaceable. Thus, tolerances of the distance between the swivel rings do not have negative effects on fitting accuracy of the support structure and thus, manufacturing is rendered easy and efficient, although the cutter system is exactly held in place without play relative to said direction parallel to the pivot axis, thereby enabling efficient driving of the cutting elements which may reciprocate relative to each other along a reciprocation axis parallel to the pivot axis.

The curved swivel rails may be positioned in a center section of the cutter system so outer sections of the cutter system may be overhanging in a cantilevered fashion to improve visibility onto the outer sections of the cutter system and thus, allowing more control to the user.

These and other advantages become more apparent from the following description giving reference to the drawings and possible examples.

### BRIEF DESCRIPTION OF THE DRAWINGS

FIG. 1a: A perspective view of a hair cutter with a cutter system that may pivot relative to the handle of the hair cutter,

FIG. 1b: a side view of the hair cutter of FIG. 1a during shaping operation, wherein the cutter system, with its skin contact surface, is placed on a user's chin to remove hair therefrom,

FIG. 2: a perspective view of the cutter head of the hair cutter of FIG. 1a, showing a support structure including a pair of ring-like, curved swivel rails allowing the cutter system to swivel about a swivel axis relative to a lower support frame structure that may be attached to the handle of the hair cutter, wherein the Figure shows that the pivot axis extends in the skin contact surface defined by an upper cutting element of the cutter system,

FIG. 3: a perspective view of the cutter system forming a replaceable cartridge including a pair of cutting elements movably supported relative to each other by a support structure that includes said pair of ring-like curved swivel rails attached to a bottom surface of the cutter system,

FIG. 4: a perspective view of the cutter head from a different point of view to show swivel stoppers limiting the swivel range,

FIG. 5: showing a detail from FIG. 4, namely one of the curved swivel rails received in a shell bearing with one of the swivel stoppers limiting the swivel range and showing a locker for holding the curved swivel rail in a fixed position relative to a direction parallel to the pivot axis,

FIG. 6: a back view of the cutter head, showing a bottom surface of the cutter system with a driver attached to a lower cutting element and extending through a window in a lower part of the support structure,

FIG. 7: a side view of the cutter head, showing a biasing device including a spring for urging the cutter system to swivel about the swivel axis into a home position relative to the lower support frame structure,

FIG. 8: a side view of the cutter head with a cross-section taken through one of the shell bearings as taken along line A-A in FIG. 6 to show one of the curved swivel rails received in a shell bearing and the four-point bearing structure thereof,

FIG. 9: an enlarged cross-sectional view of a detail of FIG. 8 which is marked by “X” in FIG. 8, wherein such detailed view shows the four-point structure of the shell bearing receiving the curved swivel rail,

FIG. 10: a schematic bottom view on the underside of an alternative cutter head with a different curved swivel rail design,

FIG. 11: a schematic perspective bottom view of the cutter head as per FIG. 10 and

FIG. 12: a perspective view of the different curved swivel rails of the cutting head of FIGS. 10 and 11.

### DETAILED DESCRIPTION OF THE INVENTION

So as to allow for more comfortable shaving and/or trimming with self-adaption of the cutter blades to the skin contour and, at the same time, to reduce the risk of skin irritations or even skin injuries due to projecting support elements, an improved swivel support structure is suggested to allow the swivel axis position to be chosen advantageously without sacrificing effective driving of the cutting elements and without needing bulky support arms.

More particularly, it is suggested the cutter system may swivel relative to a handle of the trimmer/shaver about a swivel axis which is substantially parallel to a skin contact surface defined by one of the cutting elements to be placed on a skin, wherein such skin contact surface may be defined by the top surface of the cutter system.

More particularly, the swivel axis of the cutter system may be positioned in or very close to such skin contact surface, for example slightly above the skin contact surface and thus, in the skin to be shaved when the cutter system is placed onto the skin. When the cutter system has an elongated, substantially rectangular outline, said swivel axis may be arranged parallel to the longitudinal axis of such elongated outline. When the cutter system is pressed against the skin and moved along the skin, the friction caused between the skin contact surface and the skin to be shaved tends to or tries to swivel the cutter system about the swivel axis, wherein the leverage arm of such frictional forces becomes the smaller the closer the swivel axis is to the skin contact surface.

According to an aspect, the support structure may include a plurality of ring-like, curved swivel rails attached to and projecting from a bottom surface of the cutter system opposite to the skin contact surface thereof. Such curved swivel rails define the swivel axis and may be movably received in shell bearings of a lower support frame structure that may be attached to a handle of the shaver and/or trimmer. Due to the curvature of the swivel rails, the cutter systems may swivel relative to the lower support frame structure and thus, relative to the handle of the hair cutter, when the curved swivel rails move through or along the shell bearings thereof.

Said curved swivel rails may be formed from steel wire, whereas the shell bearings may be made from plastics. More particularly, the shell bearings may form multiple points bearings, wherein each of said shell bearings may include a plurality of spaced apart bearing points together defining a curved guiding slot in which a curved swivel rail may be received. Multiple spaced apart bearing points instead of one curved slot with constant width makes the bearing structure more independent from ring diameter variations due to bending tolerances, wherein the distance or gap width between pairs of bearing points on opposite sides of a rail may be chosen smaller resulting in smaller play without increasing the tendency of the curved rail getting stuck in the respective shell bearing.

The curved swivel rails may be positioned in a center section of the cutter system so outer sections of the cutter system may be overhanging in a cantilevered fashion to improve visibility onto the outer sections of the cutter system and thus, allowing more control to the user.

For example, each of said plurality of curved swivel rails may be spaced apart from a longitudinal end section of said cutting elements by a distance ranging from 20% to 40% or 25% to 35% of the entire distance of said longitudinal end sections of the cutting elements from each other.

According to another aspect, the cutter system may be held or supported relative to the lower support structure, which is attached to the handle, only by means of the aforementioned swivel rails and the shell bearings cooperating with such swivel rails. In other words, the support structure for support, in particular pivotable or swiveling support of the cutter system relative to the handle may consist of said swivel rails and said cooperating shell bearings only. The curved swivel rails may form the only support of the cutter system relative to the lower support frame structure attached to the handle. Such simplified support structure allows for easy assembly of the cutter head and a reduced number of elements to be connected and furthermore reduces the tendency to get slammed, as it is the case with more complicated structures with redundant dimensioning and redundant fixings.

For example, the end portions or outer sections of the cutting elements may form freely projecting end portions spaced apart from the handle and the lower support structure connected thereto by a considerable gap as provided by the swivel rails and shell bearings forming the support structure.

The shell bearings may be configured to hold each of the curved swivel rings free of play and thus rigidly or fixedly in a direction perpendicular to the pivot axis, whereas in a direction parallel to the pivot axis only one swivel ring may be fixedly held, and the other swivel ring or all other swivel rings may have play or may be displaceable. Thus, tolerances of the distance between the swivel rings do not have negative effects and thus, manufacturing is rendered easy and efficient, although the cutter system is exactly held in place without play relative to said direction parallel to the pivot axis, thereby enabling efficient driving of the cutting elements which may reciprocate relative to each other along a reciprocation axis parallel to the pivot axis.

Each of said shell bearings may define a curved guiding slot having a width and a curvature matching with a thickness and curvature of the swivel rail received therein.

More particularly, each of said shell bearings, when considering a cross-sectional plane going through the ring-like, curved swivel rail received in a shell bearing, may be provided with a plurality of spaced apart bearing points together defining said curved guiding slot for a curved swivel rail and spaced apart from each other along the curved extension of the curved swivel rail.

For example, each shell bearing may be provided with four bearing points, wherein two of said four bearing points are on one side of said curved bearing rail and another two of said four bearing points are on an opposite side of said curved swivel rail.

According to an aspect, only one of said plurality of curved swivel rails may be, when considering an axis parallel to the pivot axis, fixedly received in one of said plurality of shell bearings, whereas another one or each other curved swivel rail is received in another one of said plurality of shell bearings in a manner displaceable along said axis parallel to the pivot axis.

In other words, the other shell bearing provides for play in said direction parallel to the pivot axis, so the curved swivel rail received in such other shell bearing is not fixed in said direction parallel to the swivel axis but only held in directions perpendicular to the swivel axis.

Due to such different configuration of the shell bearings with regard to a direction parallel to the pivot axis, manufacturing tolerances affecting the distance between the curved swivel rails do not have any negative effect on stiffness and rigidity of the support structure. In particular, the cutter system is held in place in a stiff and rigid manner with regard to the direction parallel to the pivot axis and thus, parallel to the reciprocation axis so driving action may be transmitted to the cutting elements in a very efficient way.

Such concept of holding the cutter system in the direction of the reciprocation axis and/or the swivel axis at only one curved swivel rail, allows for very small tolerances and thus, achieve zero or very little play.

The aforementioned lower support structure to be attached to the handle may have a substantially fork-like or Y-shaped configuration or may include a fork-shaped or Y-shaped support frame including a pair of support legs projecting from a base section of the support from towards the cutter system. End portions of said support legs may be provided with the aforementioned shell bearings, whereas an end portion of the base section facing away from the support legs may be provided with a connection portion for connecting to the handle. Such Y-shaped configuration of the lower support structure allows for a slim neck portion between the handle and the cutter head but nevertheless allows for stable and stiff support of the cutter head relative to the handle so as to allow for efficiency of driving the cutter elements. More particularly, the support legs projecting from the base section may diverge or may be inclined relative to each other at an acute angle therebetween so as to combine a lightweight design with a sufficient distance of the shell bearings at the end portions of the support legs to achieve sufficient distance between the shell bearings.

Such Y-shaped or fork-like lower support structure may include a support portion for a transmitter which transmits driving action of a motor accommodated in the handle to the cutter system of the cutter head, wherein such support portion may be provided at the aforementioned base section of the support frame, for example in a section where the support legs project from the base section. More particularly, such support section may be provided with a pivot bearing to pivotably support the aforementioned transmitter. Thus, the lower support structure may have a double function including support of the cutter system relative to the handle and furthermore, movably supporting the transmitter extending from a motor in the handle towards the cutter system. Such transmitter may have an elongated configuration or may form a bar or rod which may extend between said pair of support legs of the aforementioned Y-shaped support frame.

So as to avoid too much flexibility detrimental to efficient transmission of driving forces and/or torque to the cutting elements, said swivel axis may have a fixed position relative to a non-reciprocating one of said cutting elements and/or a fixed position relative to a handle of the shaver/trimmer. Such fixed swivel axis position allows to avoid yielding and bulky bar-linkage mechanisms.

The lower cutting element may be driven by a driver which is connected to the inner cutting element and coupled to a drive train transmitting a driving action of a drive unit.

Basically, each of the cooperating cutting elements may be driven. However, to combine an easy drive system with safe and soft cutting action, the upper or outer cutting element having the skin contact surface may be standing and/or may be not reciprocating and not rotating, whereas the lower or inner cutting element which may be the sandwiched cutting element, may reciprocate or rotatorily oscillate.

In a home position or neutral position or initial position of said cutting elements relative to the swivel axis, said cutting elements may be inclined relative to a longitudinal handle axis at an acute angle so that the skin contact and/or skin facing surface of the cutter elements faces towards a front side of the handle of the shaper/trimmer.

So as to urge the cutting elements into a specific home position, a biasing device may be associated with said swivel axis. Such biasing device may be configured to bias the cutting elements about said swivel axis towards an end of a limited swivel range. In other words, the biasing device which may include a spring device, does not urge the cutting elements into a neutral middle position from which it may swivel into opposite directions, but the biasing device tries to urge the cutting elements into an extreme swivel position or an end swivel position from which the cutting elements may swivel only in one direction.

More particularly, the biasing device may be configured to bias the cutting elements into an angular swiveling position with a smallest possible angle of inclination of the skin contact surface vis-à-vis the longitudinal handle axis. If the cutting elements swivel out of said biased home position, the plane tangential to the skin contact surface gets more and more transverse to the longitudinal handle axis and/or tries to approach a position perpendicular to said longitudinal handle axis.

Due to such biased home position in which the skin contact surface is inclined at a rather small angle relative to the longitudinal handle axis, users intuitively pull the cutter system with a front row of cutting teeth going ahead over the skin to be shaved. Thus, the position of the swivel axis on or close to the skin contact surface and the biasing device urging the cutter system towards an ultimate swivel position allows for fine adaptation of the cutting elements to the skin contour and avoids uncontrolled transverse movements potentially posing a risk of skin irritations.

Irrespective of such preferred direction of moving the cutter system, biasing the cutting elements into said home position at the end of the swiveling range may also reduce the risk of skin irritations or even skin injuries when the cutter system is moved over the skin to be shaved in the non-preferred opposite direction, i.e. when the second row of comb-like cutting teeth is the leading edge since said second row of comb-like teeth may deflect due to swiveling rather easily and gives way to the skin, wherein only very low skin contact forces are necessary at such opposite edge as the distance to the swivel axis is rather large and, thus, the leverage of such skin contact forces at the opposite edge is large.

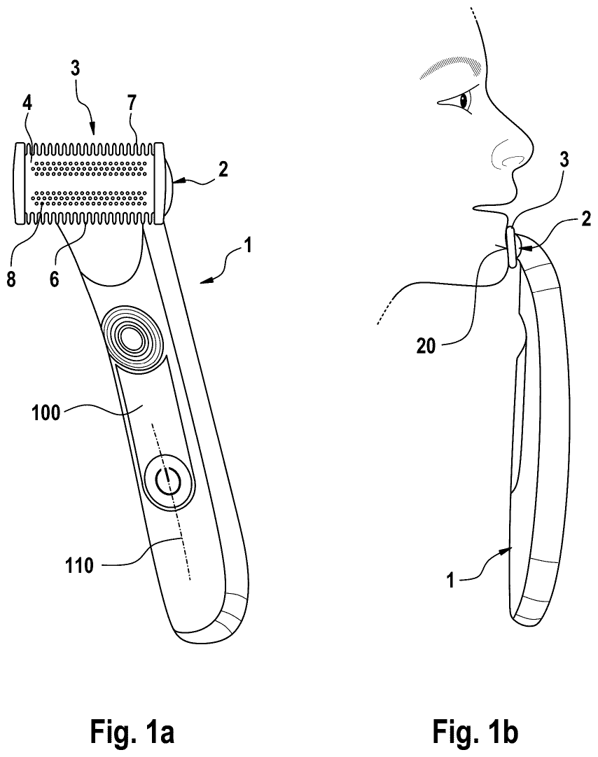

As can be seen from FIG. 1a, the cutter system 3 may be part of a cutter head 2 which may be attached to a handle 100 of a hair cutter 1 that may be a shaver and/or trimmer. More particularly, the shaver and/or trimmer may include an elongated handle 100 accommodating the electronic and/or electric components such as a control unit, an electric drive motor or a magnetic drive motor and a drive train for transmitting the driving action of the motor to the cutter system at the cutter head 2 which cutter head 2 may be positioned at one end of the elongated handle 100, cf. FIG. 1a.

The cutter system 3, including a pair of cooperating cutting elements 4 and 5 may be the only cutter system of the cutter head 2 as it is the case with the example shown in FIG. 1. On the other hand, the cutter system 3 may be incorporated into a shaver head 2 having other cutter systems such as shear foil cutters, wherein, for example, the cutter system 3 having at least one row of cooperating cutting teeth 6, 7 may be positioned between a pair of shear foil cutters, or, in the alternative, may be positioned in front of such a shear foil cutter.

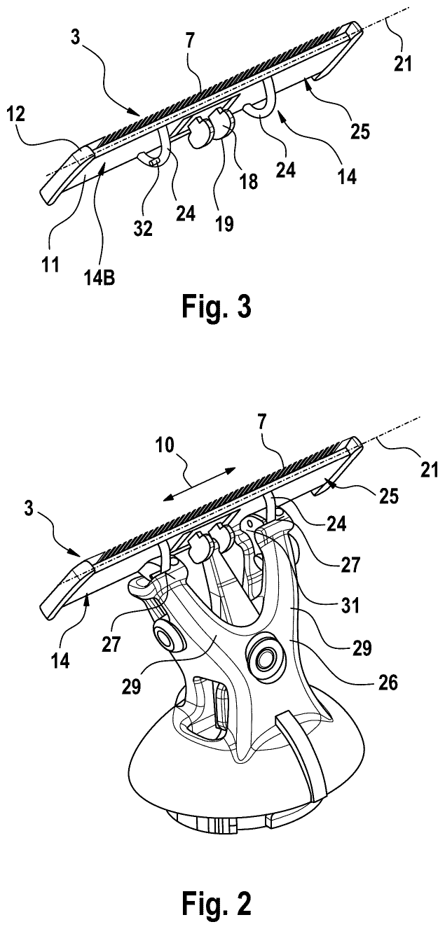

As shown by FIG. 1a and FIG. 1b, the cutter system 3 may include elongated rows of cutting teeth 6 and 7 which may reciprocate relative to each other along a linear path defining a reciprocation axis 10, cf. FIG. 2, so as to affect the cutting action by closing the gaps between the teeth and passing over each other. On the other hand, the cutter system 3 also may include cutting teeth 6 and 7 which are aligned along a circle and/or are arranged radially. Such rotatory cutting elements 4 and 5 may have cutting teeth 6 and 7 projecting substantially radially, wherein the cutting elements 4 and 5 may be driven to rotate relative to each other and/or to rotatorily oscillate relative to each other. The cutting action is basically similar to reciprocating cutting elements as the radially extending teeth, when rotating and/or rotatorily oscillating, cyclically close and re-open the gap between neighboring teeth and pass over each other like a scissor.

The drive system may include a motor accommodated in the handle 100, the shaft of which may rotate an eccentric drive pin or a drive rod 17 which is received between the channel-like contours 19 of a driver 18 which is connected to one of the cutting elements 5 which is caused to reciprocate due to the engagement of the rotating eccentric drive pin with the contours of said driver 18, cf. FIGS. 2, 4 and 6.

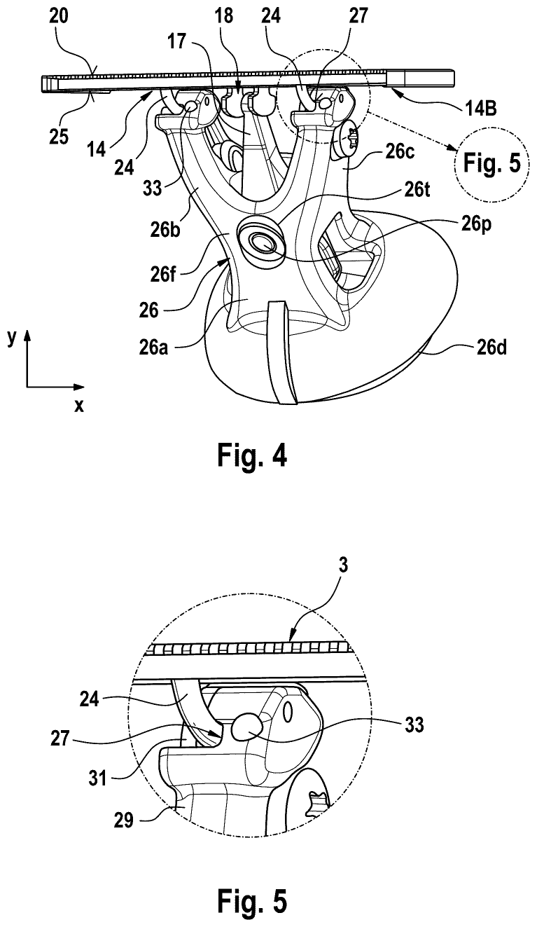

As shown by FIGS. 3, 4 and 5, the cooperating cutting elements 4 and 5 basically may have—at least roughly—a plate-shaped configuration, wherein each cutting element 4 and 5 includes two rows of cutting teeth 6 and 7 which may be arranged at opposite longitudinal sides of the plate-like cutting elements 4 and 5, cf. FIG. 4 and FIG. 5. The cutting elements 4 and 5 are supported and positioned with their flat sides lying onto one another. More particularly, the cutting teeth 6 and 7 of the cutting elements 4 and 5 touch each other back to back like the blades of a scissor.

In addition to such comb-like cutting teeth 6 and 7, the cooperating cutting elements 4 and 5 may be provided with at least one field of cutting perforations 8 arranged between the rows of cutting teeth 6 and 7 in a middle portion of the cutting elements 4 and 5. More particularly, the outer cutting element 4 defining a skin contact surface of the cutter system 3 may include at least two rows of perforations 8 which may be formed as small sized through-holes having a circular, oval, elliptical or polygonal shape.

In particular, such small sized through-holes forming the perforations 8 may have a hexagonal shape, wherein the long axis of such hexagonal through-holes, i.e. the axis going through opposite corners of the hexagonal shape, may be oriented transverse to the reciprocating axis 10 of the cutting elements 4 and 5.

So as to support the cutting elements 4 and 5 in the aforementioned position lying and/or seated onto each other back-to-back, but still allowing reciprocating movement of the cutting teeth 6 and 7 and the perforations 8 of said cutting elements 4, 5 relative to each other, the inner or lower cutting element 5 is sandwiched between the outer cutting element 4 and a support structure 14 which may include a lower frame 11 supporting the inner or lower cutting element 5 and an outer frame 12 holding the outer cutting element 4.

More particularly, said support structure 14 may define a gap in which the inner or lower cutting element 5 may move relative to the outer or upper cutting element 4, wherein the inner cutting element 5 is slidably guided in said gap.

The cutting element 4 may be rigidly or fixedly fastened to outer frame 12. For example, the cutting element 4 may be welded or glued to the outer frame 12.

The upper cutting element 4 may define, with its top surface facing away from the handle 100, a skin contact surface 20 with which the cutter system is to be placed onto a user's skin to remove hairs, cf. FIG. 1b. More particularly, the skin contact surface 20 lies on the skin to shave short hairs by means of the perforations 8 and cut longer hairs by means of the cutting teeth when the cutter systems is drawn over the skin, whereas the cutter system 3 may be used in a different orientation when trimming sideboards, for example, with the cutting teeth 6 touching the skin under an acute angle.

Depending on the cutting elements and the type of cutter system, such top surface and thus, the skin contact surface 20 may be substantially planar or in the alternative slightly barrel-shaped or it may be defined by a tangential plane onto a plurality of slightly dome-shaped or cylindrical cutting surfaces together defining the skin contact surface 20. For example, the skin contact surface 20 may be defined by an outer surface of an upper one of a pair of cutting elements 4 reciprocating relative to each other, wherein such upper cutting element 4 may be provided with at least one field of perforations 8 for shaving short hairs or with a plurality of comb-like long hair cutters, as it is known per se.

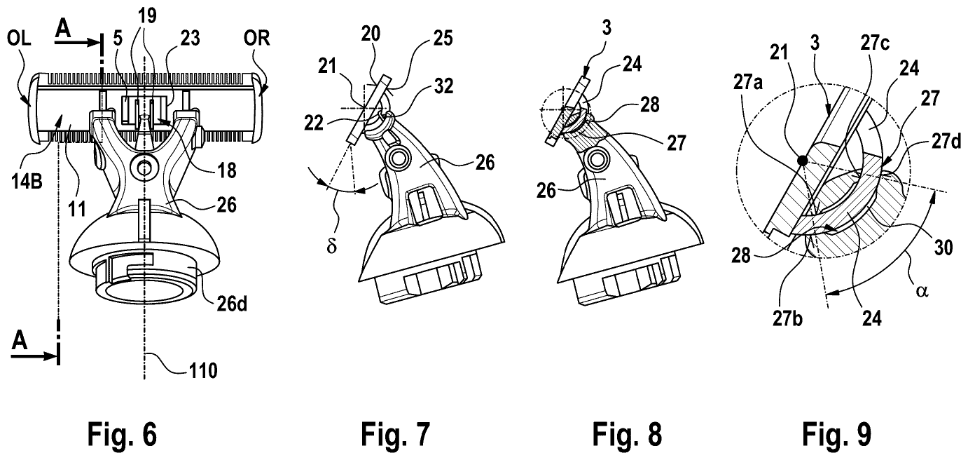

As can be seen from FIGS. 6 and 7, the cutter system 3 may be swivelably supported relative to the handle 100 of the electric hair cutter 1 in terms of a shaver/trimmer, about a swivel axis 21 which may extend substantially parallel to the axis of reciprocation 10 and/or parallel to the skin contact surface 20 of the cutter system 3.

Said swivel axis 21 may be positioned close to the cutting elements 4 and 5, in particular on or even slightly above the skin contact surface 20 defined by the upper or outer cutter element 4, cf. FIGS. 2, 3 7-9.

Due to the swivel axis 21 being position on or very close to the skin contact surface 20, good responsiveness of the swiveling of the cutting elements 4, 5 and, thus, good adaption to the skin contour for different users may be achieved even when different users apply different levels of skin contact pressure, since the swivel axis 21 positioned close to the skin contact surface 20 reduces the lever arm length of friction forces and thus, reduce the torque and swiveling effect of friction. When the cutter system 3 is pressed against the skin and moved along the skin, the friction caused between the skin contact surface 20 and the skin to be shaved tends to or tries to swivel the cutter system 3 about the swivel axis 21, cf. FIG. 1b, wherein the lever arm of such frictional forces becomes the smaller the closer the swivel axis 21 is to the skin contact surface 20.

More particularly, the swivel axis 21 may be positioned slightly under or directly on or even slightly above the skin contact surface 20. Such position significantly reduces the leverage of frictional forces relative to the swivel axis 21 and, thus, swiveling torque caused by such frictional forces on the one hand and allows for a compact, space-saving arrangement of the support structure 14 on the other hand.

So as to avoid too much flexibility detrimental to efficient transmission of driving forces and/or torque to the cutting elements, said swivel axis 21 may have a fixed position relative to a non-reciprocating one of said cutting elements 4 and/or a fixed position relative to the handle 100 of the hair cutter 1. Such fixed swivel axis position allows to avoid yielding and bulky bar-linkage mechanisms.

The support structure 14 may include a plurality of or a pair of ring-like curved swivel rails 24, the curvature of which may extend in planes substantially perpendicular to the aforementioned pivot axis 21. Said swivel rails 24 may be spaced apart from each other and may be arranged parallel to each other so they may together define the aforementioned pivot axis 21.

More particularly said swivel rails 24 may have a curvature which is circular, wherein each of the curved swivel rails 24 may form a ring segment or a segment of a circle. In particular, each of the curved swivel rails 24 may have a substantial half-ring shape.

As can be seen from FIGS. 3, 6 and 9, said curved swivel rails 24 may be rigidly attached to and may project from a bottom section 14B of the support structure 14 and thus from the bottom surface 25 of the cutter system 3, wherein said bottom surface 25 may be formed by the aforementioned lower frame 11 of the support structure 14.

More generally, the cutter system 3 may form a replaceable cartridge, cf. FIG. 3, that may be attached to a lower support frame structure 26, cf. FIG. 2 and FIG. 4, which lower support frame structure 26 may be attached to the handle 100 of the hair cutter 1. When the cutter system 3 is replaceable and may be removed from the lower support frame structure 26, said lower support frame structure 26 may be fixedly attached to the handle 100 and does not need to be removably attached thereto what nevertheless may be the case.

In the alternative, the cutter system 3 and the lower support frame structure 26 may together form a replaceable unit that may be replaced when the cutting elements 4, 5 have lost sharpness and cutting efficiency. When the entire cutter head 2 formed by the cutter system 3 and the lower support frame structure 26 is replaceable, the cutter system 3 may be connected to the lower support frame structure 26 in a way that does not need to be removable.

As can be seen from FIGS. 2, 3, 4 and 6, the pair of curved swivel rails 24 may be positioned in a center section of the bottom surface 25 so outer sections OL and OR of the cutting elements 4, 5 may form a cantilevered structure overhanging and/or freely projecting from said center section which is supported by the curved swivel rails 24. Such cantilevered structure of the cutter system with freely projecting outer sections OR and OL improve visibility on the outer edges of the cutting elements and thus, makes use of the cutter system easy and gives the user control.

As can be seen from FIG. 6, the aforementioned center section and each of the outer sections OR and OL may form about one third of the cutter system 3. More particularly, the curved swivel rails 24 may be spaced apart from a longitudinal end section of said cutting elements 4, 5 by a distance l ranging from 20%-40% or 25%-35% of the entire distance L of said longitudinal end sections of the cutting elements 4, 5 from each other. Said entire distance may correspond to the maximum longitudinal extension of the cutter system 3.

As shown by FIGS. 4 and 5, each of said curved swivel rail 24 is slidably received in a shell bearing 27 attached to the lower support frame structure 26. More particularly, the lower support frame structure 26 may include a forked upper portion including a pair of support arms 29, cf. FIGS. 2, 4 and 6 extending from the handle 100 towards the cutter system 3, wherein at the end of such support arms 29 said shell bearings 27 may be provided.

More particularly, said lower support frame structure 26 may consist of or may include a fork-shaped or Y-shaped support frame 26f including a pair of diverging support legs 26b, 26c inclined to each other at an acute angle, said pair of support legs 26b, 26c projecting from a base section 26a of the support frame 26f towards the cutter system 3, cf. FIG. 4 and also FIGS. 2 and 6. Said base section 26a may form a support column attachable to the handle 100 of the hair cutter, in particular to an upper end portion of said handle 100. More particularly, a lower end portion of the base section 26a of the Y-shaped support frame 26f facing away from the support legs 26b, 26c may be provided with a connection portion 26d to be connected to the handle 100, wherein such connection portion 26d may be configured for releasable connection to the handle 100. For example, a screw-like or trap-like locking portion may be part of said connection portion 26d, cf. FIG. 6.

The end portions of said support legs 26b, 26c projecting towards the cutter system 3 may be provided with the aforementioned shell bearings 27, cf. FIG. 2.

As can be seen from FIG. 4, the base section 26a of the Y-shaped lower support structure 26 may be provided with a transmitter support portion 26t for movably supporting the aforementioned drive rod 17 forming a transmitter for transmitting driving action from the motor in the handle 100 to the cutter system 3. More particularly, such transmitter support portion 26t may include a transmitter pivot bearing 26p for pivotably supporting said transmitter in terms of the aforementioned drive rod 17. For example, such transmitter pivot bearing 26p may provide for a pivot axis substantially perpendicular to a plane containing the reciprocation axis 10 and extending from the cutter system 3 to the handle 100. Nevertheless, depending on the type of transmitter movements, other types of bearings such as a universal joint bearing may be provided at the lower support structure 26 for movably supporting the transmitter.

Each of said shell bearings 27 includes a curved guiding slot 28 receiving one of said curved swivel rails 24 so the curved swivel rails 24 may slide through said shell bearings 27. Due to the curvature of the swivel rails 24, the cutter system 3 swivels about swivel axis 21 when the curved swivel rails 24 slide through the shell bearings 27.

As can be seen from FIG. 9, the curved guiding slots 28 of the shell bearings 27 do not have a continuous curved slot configuration, but may be formed by a plurality of spaced apart bearing points 27a-d. Such bearing points 27a-d are no “points” in mathematical terms, but do form some area and do have some extension along and around the curved swivel rails 24, but nevertheless the extensions of said bearing points 27a-d are such short that they may be considered bearing points which, when taken alone, do not take up bending torques and do not show canting relative to the surface of the curved swivel rails 24.

For example, as shown by FIG. 9, the bearing points 27a-d may be arranged in pairs on opposite sides of a curved swivel rail 24. In particular, pairs of bearing points 27a, 27b on the one hand and 27c, 27d on the other hand may be positioned on opposite sides of the curved swivel rail 24, in particular on a radial inner side and a radial outer side when considering the curved shape of the swivel rails 24 as it can be seen in the cross-sectional view of FIG. 9 going through the shell bearing 27 and perpendicular to the pivot axis 21.

Said pairs of bearing points 27a-b and 27c-d may be spaced apart from each other along the curved axis of the swivel rail 24 received in the shell bearing 27, wherein the distance between such spaced apart pairs of bearing points 27a-b and 27c-d may be much longer than the extension of each bearing point. For example, as can be seen from FIG. 9, the gap 30 between said pairs of bearing points 27a-b and 27c-d may have an extension, in the longitudinal/circumferential direction of the curved swivel rails 24, which may be more than 200% or 300% or 500% of the extension of each bearing point 27a-d in said direction.

For example, the pairs of bearing points 27a-b and 27c-d may be arranged to define an angle α relative to pivot axis 21, which angle α may range from 30° to 120° or 45° to 100° or 60° to 90°, cf. FIG. 9.

Said bearing points 27a-d together define the curved guiding slot 28 which may have a width exactly matching the thickness of the curved swivel rails 24 to hold the curved swivel rails exactly in position without any play in a direction perpendicular to the swivel axis 21.

On the other hand, when considering a direction parallel to the pivot axis 21, it is only one of the swivel rails 24 that is fixedly held in position by one of the shell bearings 27. As can be seen from FIG. 2, FIG. 4 and FIG. 5, one of the shell bearings 27 maybe “closed” by means of a locking plate 31 which may be attached to a side of the shell bearing 27 after the curved swivel rail 24 has been inserted into the shell bearing 27. Such removably attached locking plate 31 renders assembling of the cutter head too easy. Nevertheless, it would be possible to insert a curved swivel rail into a shell bearing 27 in other ways, e.g. by means of inserting it by means of a swiveling motion about swivel axis 21 what would, however, necessitate attachment of a swivel ring to the support structure 14 after having inserted it into a shell bearing.

Irrespective of the assembling process, the shell bearing 27 holding the inserted curved swivel rail 24 exactly in place with regard to the direction parallel to the pivot axis 21, may define a curved guiding slot 28 that has a width, in said direction parallel to the pivot axis 21, matching the thickness of the curved swivel rail 24 to hold, without play, the curved swivel rail 24 and thus, the entire cutter system 3 exactly in place without play in said direction parallel to the swivel axis 21.

The other shell bearing 27 provides for play in said direction parallel to the pivot axis 21 so the curved swivel rail 24 received in such other shell bearing 27 is not fixed in said direction parallel to the swivel axis 21 but only held in directions perpendicular to the swivel axis 21.

Due to such different configuration of the shell bearings 27 with regard to a direction parallel to the pivot axis 21, manufacturing tolerances affecting the distance between the curved swivel rails 24 do not have any negative effect on stiffness and rigidity of the support structure 14. In particular, the cutter system 3 is held in place in a stiff and rigid manner with regard to the direction parallel to the pivot axis 21 and thus, parallel to the reciprocation axis 10 so driving action may be transmitted to the cutting elements 4, 5 in a very efficient way.

Such concept of holding the cutter system in the direction of the reciprocation axis 10 and/or the swivel axis 21 at only one curved swivel rail 24, allows for very small tolerances and thus, achieve zero or very little play. More particularly, tolerances of the cross-section diameter of the curved swivel rails 24 (=wire diameter) may be as low as typically +/−0.01 mm, and tolerances in the guiding slot 28 width in said direction (distance between locking plate 11 and opposing wall of slot 28) may be as low as typically +/−0.02 mm. With the goal to avoid overlap in guiding this results in nominal play in x-direction as of 0.03 mm or even less.

Furthermore, the cutter system also may be held in a stiff and rigid way with regard to movements perpendicular to the swivel axis 21 as the curved swivel rails 24 may snugly fit into the curved guiding slot 28 formed by the bearing points 27a-d of each shell bearing 27. Nevertheless, resistance or friction with regard to swiveling movements can be kept very low. This is particularly due to the fact that the curved swivel rails 24 may have a cross-section that is constant along the curved swivel rails.

In contrast to wet shavers motor driven cutting systems have the need to implement noise reduction measures in the bearing system. The “small play” approach as described is much preferred, in comparison to prior art pretensioning, because it avoids the need of additional pretensioning elements like bearing springs and also allows low swivel friction, which allows a return spring device 22 to be soft what helps to achieve an easy adaptation to the skin. If the swivel friction were too high a soft return spring would not be able to rotate the cutter system 3 back in its home position.

For example, the curved swivel rails 24 may be made from metal wire or steel wire. Irrespective of the material from which the curved swivel rails 24 are made, the surfaces of the curved swivel rails 24 may be polished and/or may have a very small surface roughness. Any other material may be chosen for the curved swivel rails 24, alternatively. E.g. the curved swivel rails 24 may be made from plastic, e.g. PP, PE or POM. A plastic material for the curved swivel rail 24 may provide the advantage that it can be more easily manufactured and connected to the support structure 14, i.e. by injection molding both the support structure 14 and the curved swivel rail 24 integral in one piece. The solution with a metal wire as material for the curved swivel rails 24 provides the advantage that the diameter or cross sectional shape of the curved swivel rails 24 is highly precise along its length with lowest deviating tolerances and that the surface roughness is very low. Also, the gliding partners metal/teel combined for the curved swivel rails 24 with plastic as e.g. POM for the shell bearings 27 provides lower friction and thus better swivel properties than having both gliding partners made from plastic.

Alternatively, to a circular cross section for the curved swivel rails 24—which cross section is mostly part of a metal wire, the cross section may have a different cross section, e.g. round, oval, symmetrical or asymmetrical, rectangular, T-shaped or in another shape. It is advantageous if the cross sectional shape provides only few contact lines or surfaces with the shell bearings 27 for reduced friction.

Further, it is understood that the curved swivel rails 24 may be provided with a curved segment which is part of a non-curved or differently curved structure overall, wherein only the curved portion will be used for the swivel bearing.

Furthermore, the shell bearings 27 may be formed from plastics, in particular a type of plastic providing for low friction. For example, the shell bearings 27 may be made from polyoxymethylene POM. In particular, a combination of a polished steel wire forming the curved swivel rail 24 and a shell bearing 27 made from POM allows for easy swiveling with low friction resistance but nevertheless avoiding any slack and undesired play of the support structure.

The biasing device or spring device 22 may be associated with said swivel axis 21 so as to urge the cutter system 3 in a desired, mutual swivel position or orientation which may be a middle orientation allowing swiveling into opposite directions or, in the alternative, an end position or end orientation allowing swiveling into one direction only.

As can be seen from FIGS. 1 and 7, in a home position or neutral position or initial position, said cutting elements 4, 5 may be inclined relative to a longitudinal handle axis 110 at an acute angle δ, cf. FIG. 7 so that the skin contact and/or skin facing surface 20 of the cutter elements 4, 5 faces towards a front side of the handle 100 of the hair cutter 1, cf. FIG. 1.

Said spring device 22 may be engaged with the lower support frame structure 26 attached to the handle 100 on the one hand and the support structure 14 on the other hand.

So as to urge the cutting elements 4, 5 into their swiveling home position, the aforementioned biasing device or spring device 22 may be associated with said swivel axis 21. Such biasing device 22 may be configured to bias the cutting elements 4, 5 about said swivel axis 21 towards an end of a limited swivel range. More particularly, as can be seen from FIGS. 3 and 7, one of the curved swivel rails 24 may be provided with a biasing pin 32 engaging with a spring element of said spring device 22 to apply a swiveling force or swiveling torque onto the cutter system 3 to urge the cutter system towards its home position.

In other words, the biasing device which may include said spring device 22, does not urge the cutting elements 4, 5 into a neutral middle position from which it may swivel into opposite directions, but the biasing device 22 tries to urge the cutting elements 4, 5 into an extreme swivel position or an end swivel position from which the cutting elements 4, 5 may swivel only in one direction.

More particularly, the biasing device 22 may be configured to bias the cutting elements 4, 5 into an angular swiveling position with a smallest possible angle of inclination δ of the skin contact surface 20 vis-à-vis the longitudinal handle axis 110. If the cutting elements swivel out of said biased home position, a plane tangential to the skin contact surface 20 gets more and more transverse to the longitudinal handle axis 110 and/or tries to approach a position perpendicular to said longitudinal handle axis 110.

Due to such biased home position in which the skin contact surface 20 is inclined at a rather small angle δ relative to the longitudinal handle axis 110, users intuitively pull the cutter system 3 with a first one of said two rows of cutting teeth 6 going ahead over the skin to be shaved.

The swivel range of the cutter system 3 may be limited by means of swivel stoppers 33, cf. FIGS. 4 and 5, wherein such swivel stoppers may be provided on the lower support frame structure 26, for example at the ends of the support arms 29, at positions neighboring the shell bearings 27, cf. FIG. 5. Such swivel stoppers 33 may be formed as protrusions projecting beyond the surrounding structures to provide for defined contact points. For example, the swivel stoppers 33 may abut against the bottom section 14 of support structure 14 of the cutter system 3 to limit swiveling thereof.

As already mentioned, so as to drive the cutting elements 4 and 5 in a reciprocating manner relative to each other, a driver 18 may be connected to the inner or lower cutting element 5, wherein such driver 18 may include a pair of spaced apart contours 19 or edges rigidly attached to the inner or lower cutting element 5 and defining a slot therebetween. A driving element such as a driving rod 17 extending from handle 100 to the cutter head 2 may be received in said slot or gap between said channel-like contours 19.

More particularly, the inner or lower frame 11 of the support structure 14 may include an elongated recess 23 or cutout extending through a bottom section of the support structure 14, wherein the aforementioned contours 19 of driver 18 may extend through said elongated cutout 23, cf. FIG. 6, to allow coupling with the driving element 17 of the drive train coming from the motor in the handle 100.

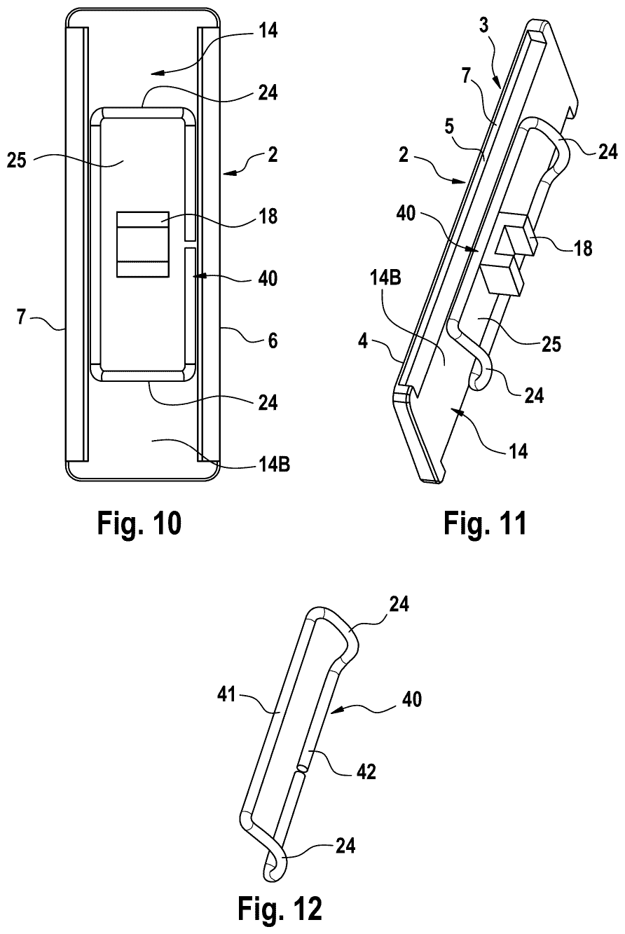

FIGS. 10, 11 and 12 illustrate an alternative design for the curved swivel rails 24. The cutter head 2 may be provided with the same features and design as that of the foregoing FIGS. 1-9 . The cutting teeth are also provided with rows of hair cutting teeth on each cutting element 4, 5 as in the previous embodiment—although these hair cutting teeth are only schematically illustrated.

FIGS. 10-12 are different to the previous embodiment in that both curved swivel rails 24 are made as one integral swivel part 40. The swivel part 40 is made from a single metal/teel wire with a 3D shape to provide both the curved swivel rails 24 and connecting extensions 41, 42 which connect both curved swivel rails in one bent wire part and also serve to provide a different, easier way to connect the swivel part 40 with the curved swivel rails 24 to the support structure 14. The support structure 14 may be provided with gaps/lots for accommodating the connecting extensions 41, 42 within the support structure. By this, any kind of fixation of the swivel part 40 on the support structure 40 is available, as e.g. welding, snap fit, press fit, plastic overmelting, insert molding or others. As the support part may be made from plastic or metal or plastic/metal material the fixation of the swivel part is adapted to the material to which it needs to be fixed. e.g. the swivel part 40 may be connected with a metal support structure by welding or a combination of form fit with welding or other methods. The swivel part 40 comprises on opposite sides the curved swivel rails 24 (for engagement with the shell bearings 27) and straight connecting extensions 41, 42 also on opposite sides to each other. The swivel part 40 may form an essentially rectangular shape if seen from top view—see FIG. 10.

In an alternative design are the curved swivel rails 24 part of the non-moveable handle or head/neck area and the bearings are part of the moveable cutter head. For this inverse, alternative design the above description may also apply with the features described appropriately.

It is to be further noted that the cutting head may be provided with hair cutting holes of any shape between the rows of hair cutting teeth 6, 7 in order to cut shorter hairs between those rows 6, 7.

It is to be noted that the above arrangement of curved swivel rails guided in shell bearings is not limited to electric type of trimmers but is applicable to all types of hair removal devices, such as electric shavers, styling devices, body grooming devices or wet razors.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Cutter system for an electric hair cutter like shaver and/or trimmer, comprising a pair of cooperating cutting elements with at least one of the cutting elements forming a skin contact surface, wherein said cutting elements are movably supported relative to each other by a support structure which provides for a swivel axis about which said cooperating cutting elements are swivelable to follow the skin contour, said swivel axis extending substantially parallel to said skin contact surface, characterized in that said support structure includes a plurality of spaced-apart ring-like, curved swivel rails attached to and projecting from a bottom surface opposite to said skin contact surface.

2. Cutter system according to claim 1, wherein said curved swivel rails is defining said swivel axis when movably received in shell bearings of a lower support frame structure to be attached to a handle of said hair cutter.

3. Cutter system according to claim 1, wherein said curved swivel rails have a circular cross-section and a constant diameter along the curved extension of the swivel rails.

4. Cutter system according to claim 1, wherein said curved swivel rails are formed by steel or metal wire.

5. Cutter system according to claim 1, wherein said curved swivel rails have a circular curvature around said pivot axis positioned substantially on the skin contact surface and form substantially half circles end portions of which are rigidly attached to the bottom surface of the cutter system.

6. Cutter system according to claim 1, wherein said curved swivel rails are positioned in a center section of said bottom surface and said cutting elements, with outer sections thereof, form a cantilevered structure overhanging from said center section supported by the curved swivel rails.

7. Cutter system according to claim 1, wherein said curved swivel rails form the only support of the cutter system relative to the lower support frame structure attached to the handle of said hair cutter.

8. Cutter system according to claim 1, wherein said curved swivel rails are configured to, when movably received in said shell bearings of the lower support frame structure, fixedly hold the cutter system in a direction parallel to said swivel axis and/or wherein only one of said curved swivel rails is configured to prevent movements of the cutter system along said swivel axis whereas another one or each other of said curved swivel rails is configured to allow for movements of the cutter system along said swivel axis.

9. Cutter system according to claim 1, wherein said curved swivel rails are configured to, when movably received in said shell bearings of the lower support frame structure, fixedly hold the cutter system in a radial direction perpendicular to said swivel axis.

10. Cutter system according to claim 1, wherein each of said plurality of curved swivel rails is spaced apart from a longitudinal end section of said cutting elements by a distance ranging from about 20% to about 40% or about 25% to about 35% of the entire distance of said longitudinal end sections of the cutting elements from each other.

11. Cutter system according to claim 1, further comprising a driver for receiving driving forces and/or driving torques from a driving transmitter of the hair cutter, said driver being rigidly attached to one of said cutting elements, wherein said driver is accessible at or from said bottom surface of the cutter system, wherein said curved swivel rails are positioned on opposite sides of said driver.

12. Cutter system according to claim 11, wherein said driver extends through a cutout through a bottom section of the support structure provided between said plurality of curved swivel rails.

13. Cutter system according to claim 1, wherein said cutting elements are supported by said support structure for reciprocating along a reciprocation axis that is parallel to the swivel axis.

14. A cutter head comprising a cutter system which is configured in accordance with claim 1, and a lower support frame structure configured for attachment to a handle of a hair cutter, wherein said lower support structure includes shell bearings in which said curved swivel rails are movably received, each of said shell bearings defining a curved guiding slot having a width and a curvature matching with a thickness and curvature of the swivel rail received therein.

15. Cutter head according to claim 14, wherein each of said shell bearings, when considering a cross-sectional plane going through the ring-like, curved swivel rail received in a shell bearing, is provided with a plurality of spaced apart bearing points together defining said curved guiding slot for a curved swivel rail and spaced apart from each other along the curved extension of the curved swivel rail.

16. Cutter head according to claim 15, wherein each shell bearing, when considering said cross-sectional plane going through a curved swivel rail received in a shell bearing, is provided with four bearing points, wherein two of said four bearing points are on one side of said curved bearing rail and another two of said four bearing points are on an opposite side of said curved swivel rail.

17. Cutter head according to claim 14, wherein only one of said plurality of curved swivel rails is, when considering an axis parallel to the swivel axis, fixedly received in one of said plurality of shell bearings to prevent movements of the cutter system relative to the lower support frame structure, whereas another one or each other curved swivel rail is received in another one of said plurality of shell bearings in a manner displaceable along said axis parallel to the swivel axis.

18. Cutter head according to claim 14, wherein said plurality of curved swivel rails are, when considering radial axes perpendicular to the swivel axis, fixedly received in said shell bearings to prevent radial movements of the cutter system relative to the lower support frame structure along said radial axes perpendicular to said pivot axis.

19. Cutter head according to claim 14, wherein said shell bearings form sliding contact bearings made from plastic, in particular made from polyoxymethylene.

20. Cutter head according to claim 14, wherein said swivel axis is positioned on or slightly under or slightly above the skin contact/facing surface of the cutting elements and/or in the skin or tissue of a user when the skin contact/facing surface is contacting the user's skin.

21. Cutter head according to claim 14, wherein, in a home position of said cutting elements relative to said swivel axis, said cutting elements are inclined relative to a longitudinal handle axis of a handle of said shaver/trimmer at an acute angle so that the skin contact/facing surface of the cutting elements faces towards a front side of the handle of the shaver/trimmer.

22. Cutter head according to claim 20, further comprising a biasing device for biasing said cutting elements about said swivel axis towards an end of a limited swivel range.

23. Cutter head according to claim 22, wherein said biasing device is configured to urge said cutting elements into a swiveling position with a smallest possible angle of inclination of the skin contact/facing surface to the longitudinal handle axis.

24. Cutter head according to claim 14, wherein the shell bearings differ from each other in their configuration relative to a direction parallel to the pivot axis.

25. Cutter head according to claim 14, wherein said lower support structure includes a fork-shaped or Y-shaped support frame including a pair of support legs projecting from a base section of the support frame towards said cutter system, wherein end portions of said support legs are provided with said shell bearings and an end portion of said base section facing away from the support legs is provided with a connection portion for connection to the handle.

26. Cutter head according to claim 25, wherein said base section is provided with a transmitter support portion or a transmitter pivot bearing for movably or pivotably supporting a transmitter extending between said support legs towards said cutter system.

27. Electric hair cutter like shaver and/or trimmer, comprising a cutter system which is configured in accordance with claim 1.

28. Electric hair cutter according to claim 27, wherein, in a home position of the cutting elements relative to the swivel axis, said cutting elements are inclined relative to a longitudinal handle axis of a handle of said hair cutter at an acute angle so that the skin contact/facing surface of the cutting elements faces towards a front side of the handle of the shaver/trimmer.

29. Electric hair cutter according to claim 27, wherein said swivel axis has a fixed position relative to one of said cutting elements and a fixed position relative to the handle of the hair cutter when the lower support frame structure is attached to the handle.
